(19) United States
(12) Patent Application Publication
(10) Pub. No.: US 2014/0295117 A1
(43) Pub. Date: Oct. 2, 2014

(54) COMPOSITE MATERIAL WITH PPS FIBRES, EPOXY RESIN AND/OR FURAN RESIN

(71) Applicants: Michael Rohlmann, Kamen (DE); Dieter Rossberg, Froendenberg (DE)

(72) Inventors: Michael Rohlmann, Kamen (DE); Dieter Rossberg, Froendenberg (DE)

(73) Assignee: THYSSENKRUPP UHDE GMBH, Dortmund (DE)

(21) Appl. No.: 13/983,318

(22) PCT Filed: Feb. 4, 2012
(86) PCT No.: PCT/EP12/00507

§ 371 Date: Aug. 23, 2013

(30) Foreign Application Priority Data
Feb. 7, 2011 (DE) 10 2011 010 558.1

(51) Int. Cl. B65D 85/84; C08L 71/00; C08L 81/04; C08L 63/00

(52) U.S. Cl. CPC B65D 85/84; C08L 63/00; C08L 71/00; C08L 81/04
USPC 428/36.1; 525/417; 525/410; 523/400; 524/502

(57) ABSTRACT

A composite material having reinforcing fibres and a matrix of matrix material surrounding the reinforcing fibres. The matrix material contains a resin and the reinforcing fibres contain polyphenylene sulfide.

The invention relates to a fibre-reinforced plastics structure (composite material), items that are manufactured from the fibre-reinforced plastics structure embodying this invention, and the use of such items.

Plastics structures of this kind are materials that consist of reinforcing fibres embedded in a plastics matrix. These are used in a wide variety of fields of application in the form of short-fibre-reinforced, long-fibre-reinforced or endless-fibre-reinforced components.

The subgroup “glass-fibre-reinforced plastics” comprises composite materials made of a plastic, such as polyester resin, epoxy resin or polyamide, and glass fibres. Glass-fibre-reinforced plastics are standard industrial materials. Tubes of this kind are DIN standardised and commercially available.

In the field of alkaline fluids, glass-fibre-reinforced plastics are predominantly used to hold or transport alkaline liquids. They are usually provided with a thermoplastic material, such as polypropylene, as a protective chemical coating. This protective chemical coating is provided on all surfaces that come into contact with the alkaline solutions with the aim of protecting the glass-fibre-reinforced plastics. This additional protective coating is required in particular when the temperatures of the alkaline solutions are >40° C., which increases their corrosive effect, leading to surfaces being attacked and destroyed.

At temperatures below 40° C. and low alkaline fluid concentrations a thermoplastic protective chemical coating can be dispensed with and instead this is generated from the plastics matrix itself.

The disadvantage of the glass-fibre-reinforced plastics known in the prior art is that if the protective chemical coating is damaged the glass fibres are laid bare and are directly exposed to chemical attack by alkaline fluids.

Glass is a highly chemically resistant material, but it is not alkaline-fluid-resistant and is severely attacked and destroyed by alkaline fluids. The entire composite material is affected by the destruction of the reinforcing fibres as the mechanical stability of the composite material is achieved via the reinforcing fibres. The loss of mechanical stability results in failure of the material as it is no longer able to resist the pressure and thermal load that prevails, for example, during operation of an industrial plant.

A glass-fibre-reinforced plastics tube according to the prior art is known, for example, from DE 10 2008 033 577 A1. This specification shows in particular a plastic tube that, compared to the prior art, demonstrates improved properties with regard to leak tightness, rigidity, form stability and abrasion. At the same time, the tube wall is formed by at least one centrifuge layer that is manufactured in a centrifuge and/or centrifuge casting method and at least one winding layer that is manufactured in a winding method. Although such tubes display improved properties, they are very expensive to make.

The objective of the present invention is thus to provide an alternative composite material in which both the matrix material and the fibre material is resistant to alkaline fluids at temperatures >60° C., thus reducing the probability of failure in the way described above. The objective of the invention also is to provide relevant items and uses of the composite material.

The objective is achieved via a composite material comprising reinforcing fibres and a matrix made of matrix material surrounding said fibres, the matrix material containing an epoxy resin and/or a furan resin and the reinforcing fibres polyphenylene sulphide.

The epoxy resin (EP resin for short) reacts with a curing agent, generally known as a hardener, to form a duroplastic composite material. The EP resin is based on different formulations, a bisphenol A or Novolak basis being preferred for the application used. The hardener systems are preferably based on amine systems, with both aliphatic and aromatic amines being used. However, anhydride hardeners can also be used.

In an advantageous embodiment of the invention the composite material additionally comprises additives which affect the properties of the composite material. These are selected from the group of stabilisers, bonding agents and slip agents, and are known to persons skilled in the prior art. These modifiers are based mainly on aliphatic or aromatic glycidyl ethers. But aliphatic epoxy ester resins or polyepoxide resins are also used to regulate the properties. Imidazol-based systems act as accelerants.

The composite material preferably comprises 0.05 to 35 weight percent of additives. These may be contained either in the matrix material and/or in the fibre material. According to the present invention the matrix material comprises 95 to 100 weight percent of resin and 0 to 5 weight percent of additives. The fibre material advantageously comprises 65 to 100 weight percent of polyphenylene sulphide and 0 to 35 weight percent of additives.

An advantage is that the composite material according to the present invention is resistant to alkaline fluids with a concentration >20%, in particular said alkaline fluid being >20% NaOH. It goes without saying that the composite material also exhibits resistance to other chemicals.

The composite material of the present invention is resistant to NaOH and other alkaline fluids at temperatures >60° C.

The present invention also comprises items for holding and/or transporting alkaline liquids, said items comprising the composite material according to the invention. Advantageously, these are /pipes or containers.

These tubes/pipes and containers are manufactured from the composite material using a process known to persons skilled in the prior art. The known processes are in detail:
Winding method: the winding method combines rotating (winding mandrel) and oscillating (support) movements to enable the deposition of resin-impregnated fibres on the mandrel according to a specific winding pattern. This method can either be done by machine or manually using various different fibre structures, such as, for example, continuous filaments such as rovings, mats made of chopped fibres, randomly oriented fibre mats made of short and long fibres, woven fabric or knits.
Braiding method: in the braiding method the reinforcing fibres are deposited on a fixed core by a moving braiding machine with a rotating braiding head, thus producing a woven-fabric-like structure on the stationary core that is then impregnated with the matrix resin in a subsequent process.
Centrifuge method: in the centrifuge method the fibre reinforcement is introduced beforehand in the form of, for example, mats or woven fabrics or it is introduced into the rotational mould as chopped fibre along with the resin and any additives through the lance, a flexible feeding arm. The centrifugal force during centrifugation creates hollow bodies with outer layers rich in reinforcing agents and resin-rich, chemically resistant inner layers.

The composite material according to the invention is mainly used as a material for pipes, tubes and/or containers, whereby said pipes, tubes and/or containers are contacted with alkaline fluids. The pipes, tubes and containers are also used for alkaline fluids at increased temperatures of >60° C.

In a preferred application, the composite material is used in apparatus for an electrolysis process in which alkaline fluids are produced and/or added. Possible uses are mainly for inlets and outlets as well as in the reaction chambers of electrolysis cells.

Additional possibilities for use of the composite material according to the invention are listed below. These include, for example, apparatus for an alkaline fluid concentration process, in which the concentrations of alkaline fluids are changed, or apparatus for an extractive metallurgy process in which alkaline fluids are added and/or used, said process advantageously being the extraction of aluminium from bauxite. Furthermore, the invention relates quite generally to apparatus for processes as known in the state of the art, where alkaline fluids are added and/or used.

The invention is described in detail below by means of an embodiment by way of example and includes an investigation into the resistance of tube materials in hot alkaline fluid.

The tube materials used in the experiment were fibre-reinforced plastics. First, only the pure basic components were to be examined. The matrix materials were epoxide and vinyl ester resins as well as other types of resin which vary in their structure. Various glass and polymer fibres, such as AR glass, polyamide fibre and polyphenylene sulphide fibres were designated for use as fibre materials. Test specimens made of pure resin and fibres were supplied by commercial manufacturers. The square test specimens had an edge length of 30 mm. The individual fibres (without resin) were used as commercially supplied.

The test specimens and fibres were stored in 32 wt.% NaOH solution in PFA containers with screw caps in a drying oven for 10 days at 90° C. in order to ascertain a basic resistance of the specimens used. After these 10 days, the temperature was increased to 250° C. In so doing, the 32 wt. % aqueous NaOH solution was completely evaporated to dry 100% NaOH. All test specimens were thus exposed to a concentration range of 32% to 100% at a temperature of up to 250° C.

Some of the specimens were destroyed by the effects of the high temperature and/or chemical attack. However, the materials according to the invention, i.e. the epoxy resin and furan resin matrix materials, as well as the polyphenylene sulphide reinforcing fibres, withstood the extreme conditions of the experimental setup and thus fulfilled the initial task in full.

Advantages created by the invention:
Composite material with good alkaline resistance
Composite material resistant to high temperatures even in the presence of alkaline fluids.

1. Composite material comprising reinforcing fibres and a matrix made of matrix material surrounding said fibres, the matrix material containing an epoxy resin and/or a furan resin and the reinforcing fibres polyphenylene sulphide.

2. Composite material according to claim 1, wherein the composite material comprises as modifiers the additives selected from the group “stabilisers, bonding agents and slip agents”.

3. Composite material according to claim 1, wherein the composite material comprises 0.05 to 35 weight percent of additives.

4. Composite material according to claim 1, wherein the matrix material comprises 95 to 100 weight percent of resin and 0 to 5 weight percent of additives.

5. Composite material according to claim 1, wherein the fibre material comprises 65 to 100 weight percent of polyphenylene sulphide and 0 to 35 weight percent of additives.

6. Composite material according to claim 1, wherein the composite material is resistant to alkaline fluids with a concentration >20%.

7. Composite material according to claim 6, wherein the composite material is resistant to >20% NaOH.

8. Composite material according to claim 1, wherein the composite material is alkaline-resistant at temperatures >60° C.

9. Items for holding and/or transporting alkaline liquids, said items comprising the composite material according to claim 1.

10. Items for holding and/or transporting alkaline liquids according to claim 9, wherein said item is a pipe or tube.

11. Items for holding and/or transporting alkaline liquids according to claim 9, wherein said item is a container.

12. Use of the composite material according to claim 1 as a material for pipes, tubes and/or containers, whereby said pipes, tubes and/or containers are contacted with alkaline fluids.

13. Use of the composite material according to claim 1 as a material for pipes, tubes and/or containers, said composite material being contacted with alkaline fluids of a temperature >60° C.

14. Use of the composite material according to claim 1 in apparatus of processes in which alkaline fluids are added and/or used.

15. Use of the composite material according to claim 14, whereby said apparatus are apparatus for an electrolysis process in which alkaline fluids are produced and/or added.

16. Use of the composite material according to claim 14, whereby said apparatus are apparatus for an alkaline fluid concentration process in which the concentrations of alkaline fluids are changed.

17. Use of the composite material according to claim 14, whereby said apparatus are apparatus for an extractive metallurgy process in which alkaline fluids are added and/or used.
